(19) United States
(12) Patent Application Publication
(10) Pub. No.: US 2014/0164102 A1
(43) Pub. Date: Jun. 12, 2014

(54) Digital Advertising System and Method

(71) Applicant: ROCKLIVE PTE LTD, Singapore (SG)

(72) Inventors: Seth Bell, Manly (AU); Justin Viles, Seaforth (AU); Ben Voltz, Paddington (AU); James Voltz, Northbridge (AU); Bruce Buchanan, Clovelly (AU)

(73) Assignee: ROCKLIVE PTE LTD, Singapore (SG)

(21) Appl. No.: 13/804,848

(22) Filed: Mar. 14, 2013

(30) Foreign Application Priority Data
Dec. 12, 2012 (AU) 2012905431
Mar. 11, 2013 (AU) 2013900836

(51) Int. Cl. G06Q 30/02

(52) U.S. Cl. CPC G06Q 30/0255; G06Q 30/0242
USPC 705/14.45; 705/14.53

(57) ABSTRACT

A computer implemented method for presenting advertising to a computer user interfacing with digital content via a presentation interface, can comprise determining one or more of: (a) context data that is representative of how the computer user is interfacing with the digital content; and (b) user attribute data that is representative of one or more attributes of the computer user. Then, one can select an engagement offer from a pool of different engagement offers based, at least in part, on the previously determined context data and/or user attribute data. Thereafter, the selected engagement offer can be presented to the computer user, and in response to the computer user accepting the engagement offer, then the computer user can be presented, for example by way of their display screen, with one or more digital advertisements.

### FIELD OF THE INVENTION

The present invention relates generally to digital advertising systems and methods.

### BACKGROUND OF THE INVENTION

Typical digital advertising currently falls under two main categories, namely “search-based” advertising and “display-based” adverting. Both forms of digital advertising provide advertising relevance through active targeting.

Search-based advertising involves presenting advertisements to computer users (referred to herein interchangeably as “consumers”) based on keyword searches made by the consumers whilst performing on-line searching (e.g. using Google™, Yahoo™ and the like). Advertisers bid on keywords they would like to appear alongside (e.g. in the results page) and are typically charged on a performance based model (e.g. a “cost-per-click” model) when a consumer engages with their advertisement.

Display-based advertising involves presenting images and/or flash animation to consumers whilst consuming content across online and mobile environments. Normally advertisers using this mode of advertising are charged on a cost-per-impression (CPM) or cost-per-click (CPC) model. Traditionally, display advertisers would target their advertisements in association with a type of content currently being consumed by the consumer. In recent times, display-based advertising has evolved to additionally evaluate attributes of the consumer in order to better target the advertisements displayed to the consumer.

While digital search and display-based advertising are currently regarded as the most effective way for presenting advertising to consumers of digital content, the actual consumer engagement levels are still very low (often resulting in less than 0.1% of consumers actively following up on the advertisement).

### SUMMARY OF THE INVENTION

In accordance with a first aspect of the present invention there is provided a computer implemented method for presenting advertising to a computer user interfacing with digital content via a presentation interface, the method can comprise determining one or more of: (a) context data that is representative of how the computer user is interfacing with the digital content; and (b) user attribute data that is representative of one or more attributes of the computer user. Then, one can select an engagement offer from a pool of different engagement offers based, at least in part, on the previously determined context data and/or user attribute data. Thereafter, the selected engagement offer can be presented to the computer user, and in response to the computer user accepting the engagement offer, then the computer user can be presented, for example by way of their display screen, with one or more digital advertisements.

In an embodiment the context data is derived through evaluation of a content type (or nature) of the digital content and/or an interaction made by the computer user with the digital content.

Where the interaction relates to the purchase of goods and/or services, the context data may be representative of at least one of a type of, the value of and/or the location of the goods/services initially being sought by the computer user.

The content type of the digital content is determined through an evaluation of at least one of the following: a URL of a resource providing the digital content; scraping a webpage providing the digital content for keywords and predefined content; or application programming interface parameters associated with the digital content.

The user attribute data is representative of at least one of a time and location of the computer user when interfacing with the digital content, or alternatively or additionally, the user attribute data may be representative of one or more of the age, gender, or social media profile of the computer user.

The user attribute data may also comprise feedback data from previous engagement offers and/or advertisements presented to the computer user.

The method may also include a step of determining user attribute data for at least one other computer user, where that user attribute data other computer user(s) comprises feedback data from engagement offers and/or advertisements previously presented to the other computer user(s).

The feedback data may comprise a measure of engagement for the previously presented engagement offers and/or advertisements, or advertising revenue resulting from presentation of the presented engagement offers and/or advertisements.

The selection of what engagement offer to be presented may also be additionally dependent on the feedback data.

In addition, the method may further comprise the step of selecting the advertisement(s) from a pool of different advertisements, or the step of selecting the number of advertisements to be presented, based, at least in part, on one of the determined context data, user attribute data and/or the feedback data.

Further, the method may further comprise the step of dynamically modifying the advertisement selection post engagement, based on feedback from the preceding advertisement or preceding interaction activity by the user.

In accordance with a second aspect of the present invention there is provided a computer system for presenting advertising to a computer user interfacing with digital content via a presentation interface on q user computer, where the computer system can include a server processing module operable to:
communicate with the presentation interface to determine one or more of (a) context data representative of how the computer user is interfacing with the digital content and (b) user attribute data representative of one or more attributes of the computer user;
select an engagement offer from a pool of different engagement offers based, at least in part, on the determined context data and/or attribute data;
facilitate presentation of the selected engagement offer to the computer user; and
is responsive to the computer user accepting the engagement offer, and to facilitate presentation of one or more digital advertisements to the computer user.

In accordance with a further aspect there is provided a computer implemented method for presenting advertising by a third party advertising system to a computer user interfacing with digital content on a subscribing publisher site, the method comprising the steps of:
determining a historical performance of one or more of engagement offers that have been previously presented to the computer user and/or another computer user while accessing digital content on the subscribing publisher site and/or another publisher site subscribing to the third party advertising system;
selecting the engagement offer that achieved the best historical performance for presenting to the computer user while interfacing with the digital content; and
responsive to the computer user accepting the engagement offer, presenting the computer user with one or more digital advertisements.

The historical performance may be derived from one or more behavioural metrics which measure how engaged the user was while interacting with the previously presented advertisements. Equally, the historical performance may be derived from one or more behavioural metrics which measure advertising revenue resulting from the presentation of the advertisements.

In accordance with yet another aspect there is provided a computer implemented method for presenting advertising to computer users while interfacing with digital content provided by one of a plurality of different publisher sites subscribing to a third party advertising system, the third party advertising system being operable to:
maintain a database of digital advertisements; and
present one or more of the digital advertisements to a computer user responsive to determining an engagement trigger resulting from the computer user interfacing with digital content provided by one of the plurality of subscribing publisher sites.

In response to determining the engagement trigger the method may further comprise determining one or more of (a) context data representative of how the computer user is interfacing with the digital content and (b) user attribute data representative of one or more attributes of the computer user; selecting an engagement offer from a pool of different engagement offers stored in the database based, at least in part, on the determined context data and/or user attribute data; and presenting the selected engagement offer to the computer user before presenting the one or more digital advertisements.

Responsive to determining the engagement trigger the method may further comprise determining a historical performance of one or more of engagement offers that have been previously presented to the computer user and/or another computer user while accessing digital content on a subscribing publisher site; and selecting the engagement offer that achieved the best historical performance for presenting to the computer user prior to presenting the one or more digital advertisements.

In accordance with a still further aspect there is provided computer software which, when implemented by a server computer, is operable to cause the server computer to carry out the method in accordance with the method as described herein.

In the context of the present specification the term ‘digital content’ is to be construed in a broad sense and will be understood to include within its scope any form of visible and/or audible digital content. Non-limiting examples include digital content found on online sources (e.g. web pages, mobile applications, etc.) providing publications (e.g. news websites), e-commerce listings (e.g. eBay listings), articles, pictures, videos (e.g. YouTube, Vimeo, etc.), audio files (e.g. digital music downloaded through a website), charts, and the like.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic of a four dimensional advertisement model, in accordance with an embodiment of the present invention;

FIG. 2 is a basic process flow for an embodiment of the present invention;

FIG. 3 is a schematic of a system for implementing an embodiment of the present invention;

FIG. 4 is an example screen shot illustrating engagement points for a survey module, in accordance with an embodiment;

FIG. 5 is a detailed process flow, according to an embodiment of the present invention; and

FIG. 6 shows an example engagement journey for a user transacting on an e-commerce website, in accordance with an embodiment; and

FIG. 7 shows an example engagement journey for a user transacting with a poll/survey on a publisher website, in accordance with an embodiment.

### DETAILED DESCRIPTION OF PREFERRED EMBODIMENTS

Embodiments of the invention described herein relate to methods for presenting advertisements to a computer user (hereafter “consumer”) while viewing or otherwise interfacing with any form of digital content (provided by a publisher) on their computer device. Herein, the term “interfacing” is to be construed in a broad sense and includes within its scope scenarios where the user is actively interfacing with the digital content (e.g. selecting content, inputting data, entering instructions, or otherwise actively interacting with the digital content), as well as scenarios where the user is simply viewing or otherwise passively interfacing with the digital content.

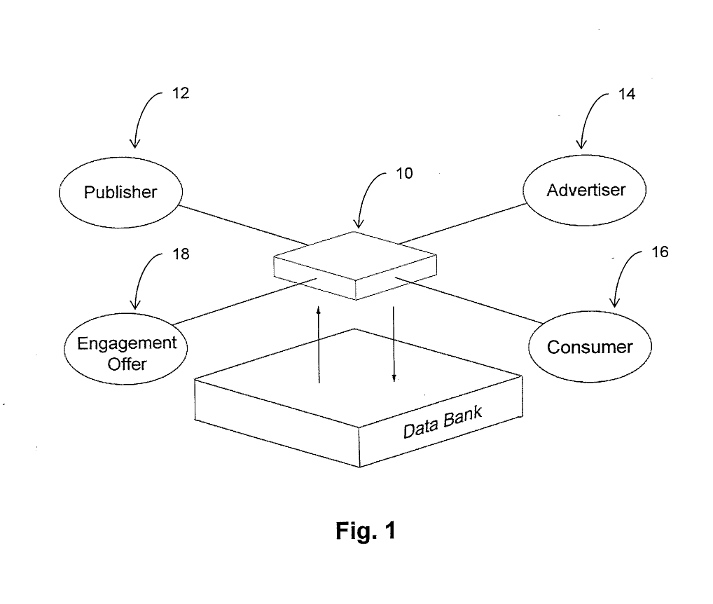

More particularly, and with reference to FIG. 1, the embodiments of the present invention relate to a four dimensional advertising model hosted by an advertisement system 10 that includes a suitable computing system and associated hardware/software. The advertising model takes into consideration the interests of the publishers 12, advertisers 14 and consumers 16, as will become evident from the following description.

Key to the four dimensional advertising model is an “engagement offer” 18, which term is used herein to refer to any form of offer which is either contextually relevant to how the consumer is interfacing with the digital content and/or relevant to one or more user attributes of the consumer. The engagement offer 18 is displayed in association with the digital content and aims to encourage the user to engage with the offer, which according to embodiments described herein involves, for example, the consumer selecting the engagement offer (e.g. by way of a mouse click, touch screen selection or some other suitable offer selection). In this sense, the engagement offer 18 differs from traditional digital advertisements in that its primary function is not to sell a particular product or service, but instead is a mechanism for encouraging the consumer to initially engage with the advertisement system 10 in a positive sense.

A non-exhaustive list of the different types of engagement offers 18 that may be presented to a consumer according to embodiments described herein, include:
coupons, discounts, vouchers, credits for goods/services
simulated “scratch and win” games, potentially revealing a prize
transaction relevant offers (e.g. chance to win back, or discounts, etc. on related transactions)
surveys and polls (which typically display results)
opportunities to participate in audience profiling or market research
competitions
sampling (products)
video images and/or audio content
free games
access to exclusive/deeper/additional publisher content
award points (e.g. loyalty points, frequent flyer points, etc.)
cash back offers

Responsive to the consumer engaging with the engagement offer 18, they are taken on an “engagement journey” which involves presenting the consumer with one of more advertisements (paid for by the advertisers 14) that are tailored for the consumer based, at least in part, on behavioural, contextual and/or demographic attributes determined by the advertising system 10.

Through extensive testing, it has been found that initiating engagement with the advertisement system 10 by way of an engagement offer results in a more positive and deeper engagement with advertisements subsequently presented to the consumer (i.e. during the engagement journey) than if those advertisements were presented in the traditional search or display based manner, as described in the preamble. In turn, the consumer is more likely to continue to engage with the advertisement system 10, thus creating a sustainable advertising revenue module which is of benefit to each of the advertisement system 10, publishers 12 and advertisers 14.

According to particular embodiments, the engagement offer 18 does not directly translate into any advertising revenue (indeed, in particular embodiments where the offer relates to a prize or the like, the offer may in fact represent an initial cost to the advertisement system 10 and/or the other parties shown in the four dimensional model of FIG. 1). In contrast, the advertisements presented thereafter (which may be any suitable form of digital advertisement) will typically result in advertisement revenue being generated through presentation to the consumer, based on any suitable payment scheme agreed by the advertisement system 10 and the individual advertisers 14.

### Basic Process Flow

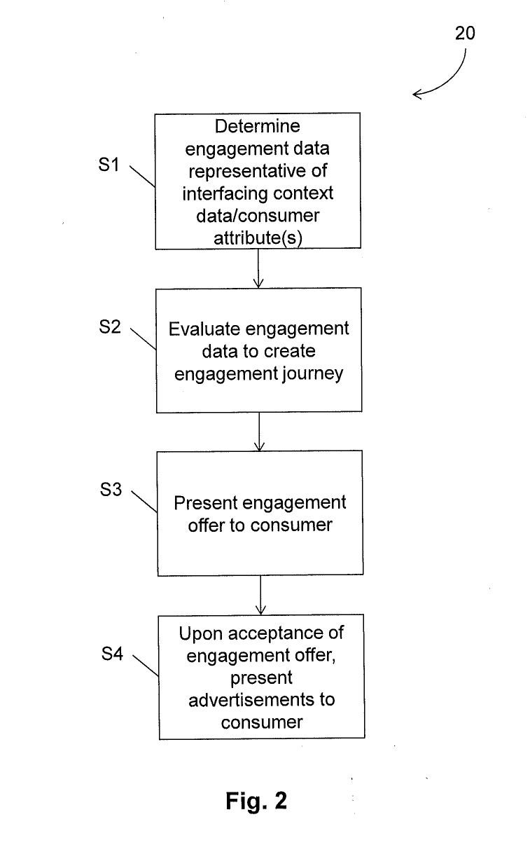

With additional reference to FIG. 2, there is shown a basic process flow 20 for engaging with a consumer who is interfacing with digital content provided by a publisher 12 (e.g. by way of a browser, mobile application, or via some other suitable digital medium).

Step S1 involves determining the interfacing context and/or consumer attribute(s) data, responsive to the occurrence of an engagement trigger. As will be described in more detail in subsequent paragraphs, the interfacing context and/or consumer attribute(s) are determined from engagement data collected while the consumer is interfacing with the digital content.

The engagement trigger may comprise or be supplied by the consumer completing a transaction, uploading or downloading a file, submitting a post in a forum, entering a competition, loading a webpage, or based on any other predefined identifiable consumer response or action.

At step S2, the engagement data together with any other data deemed relevant for the engagement (e.g. behavioural data, demographic data) is evaluated by the advertisement system 10 to generate a tailored engagement journey for the consumer, that can include, for example, an initial engagement offer 18, followed by one or more advertisements from am advertiser 14.

At step S3, the engagement offer 18 is presented to the consumer 16. The engagement offer may, for example, be presented via the display on their computing device as text (e.g. in-line with the digital content, or overlayed), in a flash banner, by way of audio content and/or video images, messaging (e.g. text message), or via any other suitable presentation means. The mechanism used to carry the engagement offer 18 is herein referred to as an “asset”.

At step S4, responsive to the consumer 16 engaging with the engagement offer 18, the consumer 16 continues on the engagement journey, during which they are presented with the one or more advertisements determined in step S2. The advertisements are presented to the consumer in a sequence of “modules”. The modules may, for example, be pop-up banners, forms or the like suitable for conveying the advertisement. It will be understood that each of the modules presented to the consumer 16 during the journey may have different functional and aesthetic variations.

### Example System Configuration

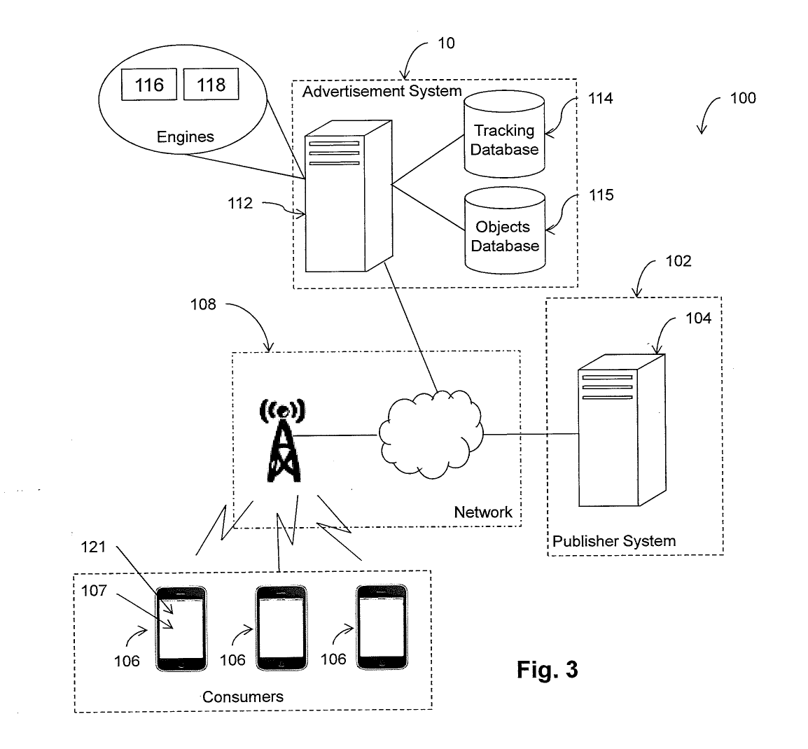

With reference to FIG. 3, there is a shown an example of a computing system 100 in which an embodiment of the invention may be implemented. The computing system 100 comprises a publisher system 102 comprising a web server computer 104 hosting a website which presents publisher content.

One or more consumer computer devices (in this case being in the form of Internet-enabled smartphones 106 or other consumer digital device) communicate with the website via a client browser 107 resident thereon. The communication is made over a network in the form of a mobile broadband communications network 108. According to embodiments described herein, the website is optimised for a mobile browser.

A computer readable script 121, hereafter referred to as a “widget script”, is placed within the publisher content (in the presently described embodiment, being communicated with the HTML page code for the website). The widget script 121 is executed client-side (i.e. on the client browser) and is operable to gather and communicate the engagement data to the advertisement system 10, and thereafter generate and display engagement journey objects on a consumer browser 107.

The widget script 121 is further operable to track behavioural metrics which are representative of a level/measure of engagement for the consumer during an engagement journey. According to one, exemplary illustrated embodiment, the behavioural metrics are tracked by API calls generated by the widget script 121 and include the following metrics relevant to each engagement offer 18, asset, advertisement and module (hereafter collectively referred to as “engagement objects”) presented to the consumer during an engagement journey:
asset impressions—a count for each asset which is incremented whenever the asset was displayed in the browser 107
asset clicks—a count for each asset which is incremented whenever the consumer clicks on (or otherwise selects) the asset;
engagement offer take-ups—a count for each engagement offer which is incremented whenever the consumer accepts the engagement offer (e.g. selects a button agreeing to take up the offer);
engagement offer skips/declines—a count for each engagement offer which is incremented whenever the consumer exits or continues on the engagement journey without taking up the engagement offer;
module impressions—a count for each module which is incremented whenever the module is rendered by the widget script 121;
module completions—a count for each module which is incremented whenever the consumer completes the module (e.g. by transitioning to another module or reaching an exit stage);
advertisement impressions—a count for each advertisement which is incremented whenever an advertisement is rendered into a module by the widget script 121;
advertisement take-ups—a count for each advertisement which is incremented whenever the consumer accepts an advertised offer;
request further information—a count for each advertisement which is incremented whenever the consumer requests further information about the advertisement before taking up the offer or passing on the offer;
advertisement skips—a count for each advertisement which is incremented every time a consumer does not take up an offer;
advertisement declines—a count for each advertisement which is incremented each time a consumer actively declines an advertised offer (e.g. selects a reject button for the displayed advertised offer);
advertisement shares—a count for each advertisement or engagement offer which is incremented each time a consumer shares the offer/advertisement with another person (e.g. through selection of a share icon which, once selected, is operable to send a URL link for a webpage displaying the offer/advertisement to the other person by way of a sharing or social media platform/service such as Twitter, Facebook, SMS or the like)

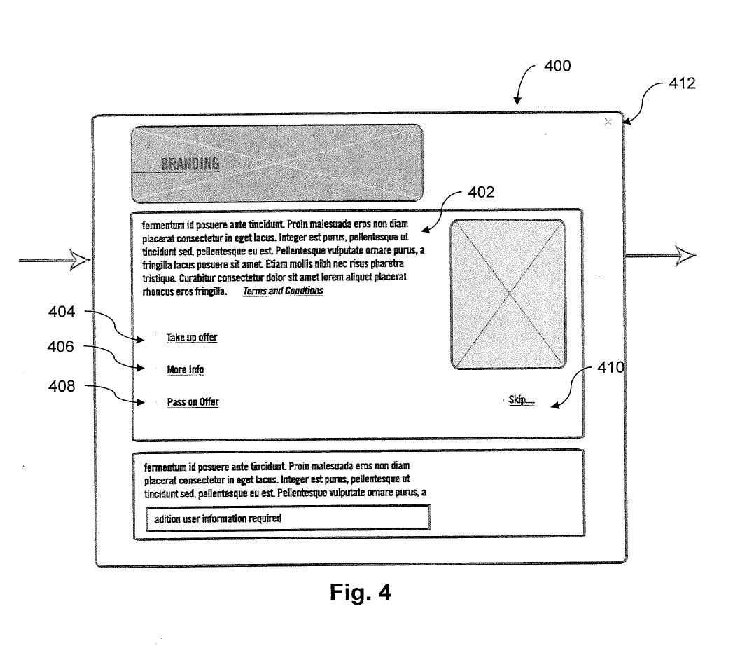

With additional reference to FIG. 4, there is shown a screen shot of an example coupon module 400 illustrating engagement points (in this case comprising a combination of radio buttons and selectable text) that are selectable by a consumer and which are recognisable by the widget script 121, once selected, to increment the count for a particular behavioural metric. As shown in FIG. 4, an advertised offer 402 is presented by the widget script 121 within the coupon module 400. At this point, the widget script 121 would have already incremented both a module impression and an advertisement impression count for the selected coupon module and advertisement. A selectable “take up offer” radio button 404 is recognised by the widget script 121 as an acceptance of the advertised offer. Also displayed are “more info” and “pass on offer” radio buttons 406, 408 which, once selected, are recognised by the widget script 121 for incrementing the “further information” and “advertisement declines” counts respectively. Skipping to the next module through selection of the “skip” radio button 410 is recognised by the widget script 121 for incrementing the “advertisement skip” count. Equally, closing the module by selecting exit button 412 is also recognised for incrementing the “advertisement skip” count.

The metrics shown above should not be seen as limiting and it will be understood that any suitable behavioural metric and associated engagement point could be implemented, depending only on the desired implementation.

Returning to FIG. 3, the advertisement system 10 comprises a server computer 112 hosting an engagement tracking database 114 (for storing the engagement data and behavioural metrics as afore-described) and an engagement objects database 115 storing the particular engagement objects, which can include engagement offers, assets, advertisements and modules. Each of the objects in the database 114 are stored in association with one or more relevant interfacing contexts and/or consumer user attributes. The server computer 112 additionally implements an engagement engine 116 and ranking engine 118 which are communicable with the respective databases 114 and 115 for dynamically generating consumer engagement journeys, as will be described in more detail below.

### Engagement and Tracking Metrics

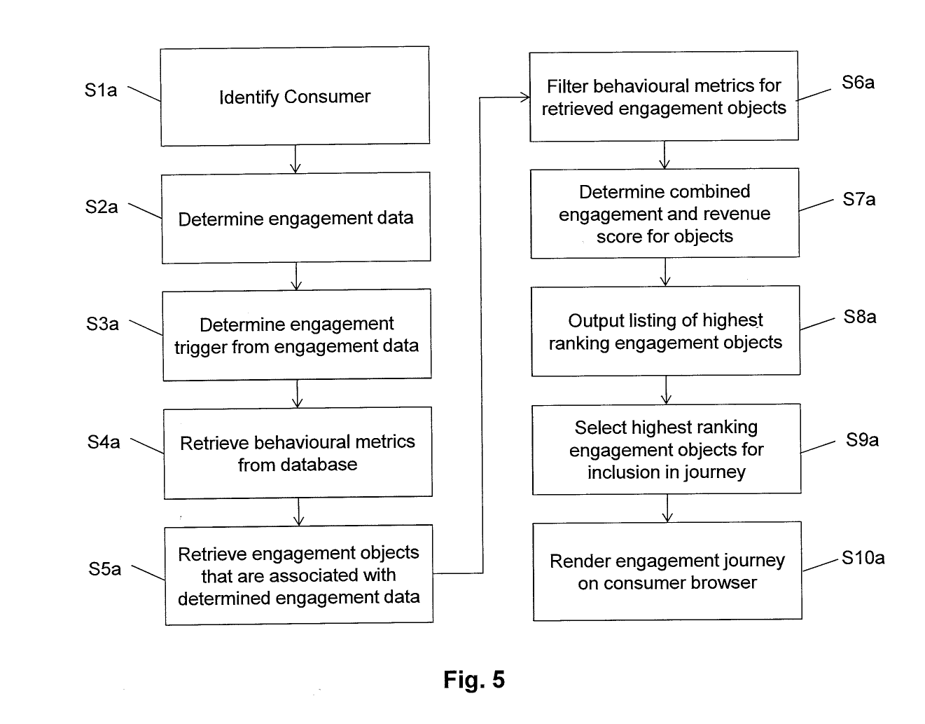

As mentioned above, the widget script 121 is operable to gather engagement data and track behavioural metrics. A particular embodiment illustrating this operation will now be described in more detail with reference to process flow diagram of FIG. 5.

According to the embodiment shown in FIG. 5, the first step S1a involves identifying the consumer 16. More particularly, each time the consumer accesses the publisher website, the widget script 121 is invoked to retrieve a unique identifier for the consumer.

According to the illustrated example, the unique identifier is created when the consumer 16 first engages with the advertisement system 10 and is held by a cookie in the consumer's client browser 107. The unique identifier is used by the widget script 121 for recording the behavioural metrics generated while completing an engagement journey (which metrics are subsequently communicated to the engagement engine 116 for storing in the tracking database 114, in association with the unique identifier for the consumer).

In instances where the widget script 121 is unable to locate a unique consumer identifier, the engagement engine 116 may instruct the widget script to display a signup module (selected from the objects database 115) for the purpose of gathering user attribute data that may be used to identify the consumer 16. In a particular embodiment, the signup module may ask the consumer to provide an e-mail address which, if matched against a consumer e-mail address stored in the tracking database 114, overrides any match determined when looking up the consumer via the unique identifier in their cookie.

In an alternative embodiment, the publisher system 102 may store user attribute data for the consumer which can be passed directly to the widget script 121 upon request, via an API call. Such user attribute data may, for example, comprise personal and/or demographic information entered by the consumer when registering with the publisher system 102, a history of products purchased by the consumer, pages visited by the consumer, among others.

At step S2a, the widget script 121 determines engagement data representative of the interfacing context. In a particular embodiment, the engagement data determined by the widget script 121 comprises at least one of the following: a URL for the website; a referring URL; screen content obtained through capturing the HTML of a current page for particular keywords and content (also known in the industry as “scraping”); through API (application programming interface) parameters passed directly to the widget script 121 by the publisher 102; a current location of the consumer; a time at the current location; a type of network over which the consumer is making the connection (e.g. wi-fi hotspot, cellular network, etc.); and/or any other data that can be determined in order to glean an understanding of how the consumer is interfacing with the digital content.

By way of example, where the consumer is interfacing with an e-commerce website, the engagement data determined by the widget script 121 may include data representative one or more attributes relating to a current transaction (e.g. type, cost, location of goods/services) that the consumer has made or in the process of making, collected through scraping the page for content. As another example, the consumer may be reading an article or other content displayed on a page of the website. In this case, the engagement data may be representative of an attribute of the content (e.g. type of content, where the content is being displayed, an author of the content, etc.), which is provided by the publisher API (or through any one of the other techniques described above).

### Generating Engagement Journeys

Still with reference to FIG. 5, at step S3a the engagement engine 116 determines an engagement trigger from the engagement data communicated from the widget script 121.

At step S4a, responsive to determining the engagement trigger, the engagement engine 116 retrieves all behavioural metrics recorded for that consumer from the tracking database 114. Depending on the desired implementation, the engagement engine 116 may additionally or alternatively retrieve behavioural metrics in aggregated form for other consumers who have the same or like demographic (e.g. age, gender, etc.). In a particular embodiment, the engagement engine 116 may limit the behavioural metrics to be retrieved to some desired period of time (e.g. within the last 3 months).

At step S5a, the engagement engine 116 passes the retrieved behavioural metrics as well as the contextually relevant engagement data gathered by the widget script 121 to the ranking engine 118. The ranking engine 118 in turn retrieves objects from the engagement object database 115 that match (i.e. are stored in association with) an interfacing context and/or consumer attribute(s) derived from the engagement data provided to the ranking engine 118.

At step S6a, the ranking engine 118 filters the retrieved behavioural metrics such that only those metrics relevant to the retrieved objects are kept for evaluation.

At step S7a, the ranking engine 118 implements a ranking algorithm which ranks the retrieved objects by a combination of an engagement score and revenue score (where applicable), as will now be described.

As its name suggests, the engagement score is associated with how well the consumer engages with the object and is determined based on the behavioural metrics recorded for that object. According to the illustrated embodiment, each type of behavioural metric is assigned a particular positive or negative score per recorded count, such that each consumer interaction with that object will result in a positive or negative point score. An example metric score table is shown below in Table 1, noting that the example scoring regime should not be seen as limiting and that any suitable scoring regime could be implemented for the recorded metrics.

TABLE 1

| Metric Type | Score Per Count |
|---|---|
| Asset Impressions | +1 |
| Asset Clicks | +2 |
| Engagement Offer Take-Ups | +2 |
| Engagement Offer Skips/Declines | −2 |
| Module Impressions | +1 |
| Module Completions | +2 |
| Advertisement Impressions | +1 |
| Further Information | +1 |
| Advertisement Take-Ups | +2 |
| Advertisement Skips | −1 |
| Advertisement Declines | −2 |
| Engagement Offer/Advertisement | +1 |
| Shares | |

The revenue score is determined by the ranking engine 118 by evaluating how much revenue resulted through presentation of the engagement objects to consumers. In a particular embodiment this is achieved by evaluating the revenue resulting from offer take-ups which may, for example, be calculated by multiplying the take-up count by the commission or fixed fee paid by the advertiser 14, though it will be understood any measure of revenue could equally be utilised for determining revenue depending only on the desired implementation. Once the engagement and revenue scores have been determined, the ranking engine 118 sums or otherwise combines the two scores to produce a combined engagement and revenue score and at step S8a outputs a listing of the highest ranking objects (based on their combined scores) to the engagement engine 116. It will be understood that any combination of engagement score and revenue score may be evaluated by the ranking engine and need not simply be the sum of the two scores. For example, the ranking algorithm implemented by the ranking engine 118 may apply a greater weighting to the determined engagement score than for the revenue score, so as to enable selection of engagement objects that are more likely to keep a consumer engaged during an engagement journey, in turn resulting in greater sustainability of the model. In this regard, the ranking engine 118 may be configured to dynamically adjust the weightings responsive to determining that levels of consumer engagement have fallen below a predefined threshold. This may be applied on an individual basis (i.e. by an evaluation of the metrics for a particular consumer) or across the consumer base as a whole (i.e. by an evaluation of the aggregated metrics).

In a particular object retrieved at step S5a does not have any behavioural metrics recorded in association therewith, then the selection of this object for inclusion in the engagement journey can be randomised.

At step S9a the engagement engine 116 selects the highest ranking engagement objects for inclusion in the engagement journey. According to embodiments described herein, each engagement journey consists of one engagement offer (i.e. displayed by way of an asset) followed by a number of modules and advertisements which is determined based on the determined interfacing context and/or consumer attribute(s). For example, an interfacing context representative of a consumer accessing an e-commerce website on their mobile phone may include a lesser number of modules/advertisements than for a consumer who is reading an article on a desktop computer. It will be appreciated that any number of different module/asset/offer configuration rules may be implemented utilising the gathered engagement data and behavioural data, depending only on the desired implementation.

At step S10a, the engagement engine 118 instructs the widget script 121 to present the engagement journey to the consumer as afore-described.

### Example Engagement Journeys

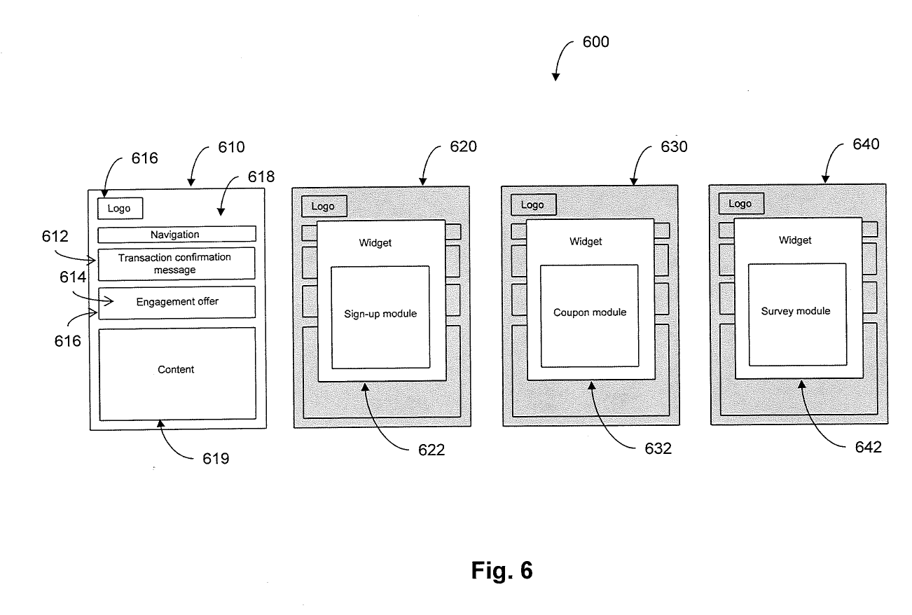

FIG. 6 shows four example screen wireframes which serve to illustrate an engagement journey 600, in this case based on a consumer interfacing with an e-commerce website. It will be understood that the engagement objects shown in FIG. 6 are only examples of the different engagement objects that might be selected by the engagement engine 116 for inclusion in a particular journey.

Wireframe 610 shows a confirmation screen which is presented to the consumer in a final stage of a transaction placed with the e-commerce website. As illustrated, the confirmation screen includes a transaction confirmation message 612 confirming that the consumer's transaction was successful. Immediately below the transaction confirmation message 612 is an engagement offer 614 selected from the objects database 115. In this example, the engagement offer 614 is presented in an asset being in the form of an inline text box 615. It will be understood that that other assets may equally be used to present the engagement offer (e.g. by way of a pop-up message, etc.) and the actual placement of the asset may vary depending on the desired implementation. Various other items of digital content are also displayed on the confirmation screen, including a publisher logo 616, navigation bar 618 and any relevant publisher content 619.

By way of example, the e-commerce website may be an online ticket sales website and the consumer may have just completed a ticket purchase for their favourite band. In this case, the engagement data collected by the widget script 121 may, for example, comprise details of the transaction (e.g. band name, ticket price, etc.) which are derived from the website HTML code. The resultant engagement offer may, for example, be the chance to win VIP backstage passes to the event.

Responsive to the consumer engaging with the offer by clicking in the box 615, the widget script 121 is instructed to display a module in the form of a pop-up sign up module 622 which overlays the confirmation screen (see wireframe 620). In this case, the sign up module 622 prompts the consumer to enter the necessary details for signing up for the engagement offer. Various fields in the sign-up module 622 may be pre-populated by the widget script 121 using details entered by the consumer while completing the transaction on the e-commerce website (e.g. name, address, date of birth, etc.). Using the example from above, the sign up module 622 may prompt the consumer to confirm their personal details for entering the VIP backstage pass promotion.

After having completed the sign up module 622, the widget script 121 is instructed to display a coupon pop-up module 632 including one or more coupon advertisements selected from the engagement objects database 115 (see wireframe 630). For example, the selected coupons may provide discounts on travel related services provided by a selection of the advertisers 14.

Wireframe 640 depicts a final module for the engagement journey in the form of a survey module 642 which displays one or more surveys that the consumer has the option of completing. For example, the survey module 642 may display a political survey with the consumer's answers captured by the widget script 121 and communicated back to the engagement engine 116 for storing in the engagement behavioural database 114. Although not illustrated in the widget screens of FIG. 6, each of the modules displayed by the widget script 121 include an option for the consumer to skip that module, which is recorded by the widget scrip 121 for increment the associated behavioural metric.

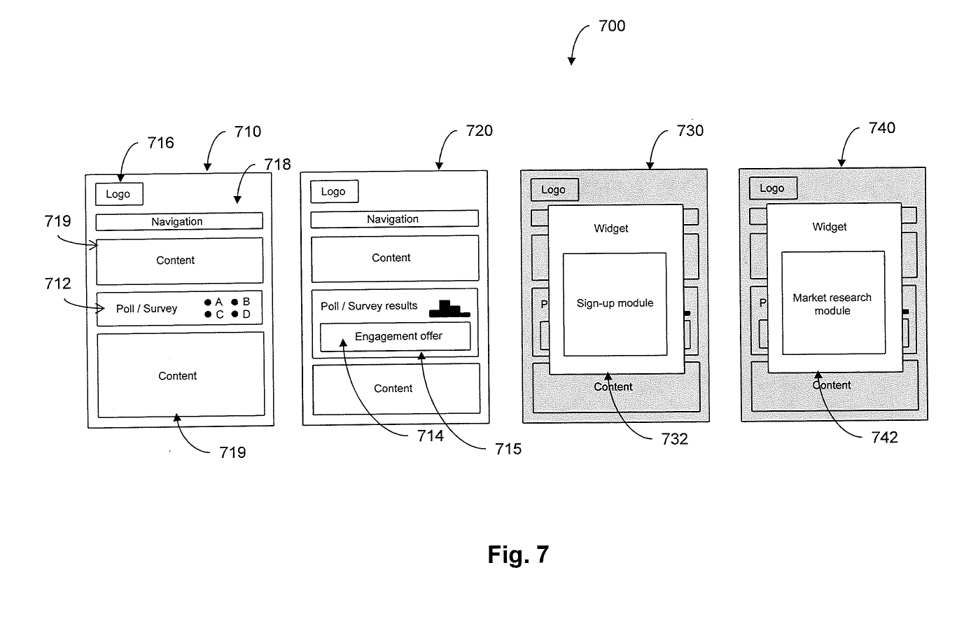

With reference to FIG. 7, there is illustrated another example engagement journey. In this example, the consumer is completing a poll on a news website which asks the consumer to select their favourite travel destination (e.g. by way of selectable radio buttons corresponding to different travel destinations). Screen wireframe 710 shows an example screen layout for the publisher site whereby the poll 712 is positioned between related publisher content 719. Again, a logo 716 and navigation bar 718 are also displayed.

Responsive to the consumer responding to the poll (i.e. by selecting one of the radio buttons), the widget script 121 is triggered to display an engagement offer 714 in an inline text box 715 immediately below the results of the poll (see wireframe 720). Using the example from wireframe 710, the engagement offer might be the chance to win free flights.

Responsive to the consumer clicking the box 715, the widget script 121 is programmed to display a sign-up module 732 for confirming the consumer details to enter the promotion, as shown in wireframe 730.

Wireframe 740 depicts the final screen presented to the consumer as part of the engagement journey, whereby they are presented with a market research module 742 asking a series of market research questions.

From the above examples, it can be seen that not all modules presented to a consumer during the journey need include explicit advertising content. For example, where only a small or no behavioural or other consumer attribute data is recorded for the consumer, the engagement engine 116 may present a survey (as depicted in wireframe 740) or the like in one of the modules seeking further information about the user, which may then be used to dynamically determine the advertising content of subsequent modules to be presented in an engagement journey.

Further, according to some embodiments, dependent on a consumer response to one or more modules, the number and or advertising content or otherwise of subsequent modules may be dynamically modified by the engagement engine 116 so as to optimise the relevance of the engagement journey. For example, where the consumer has skipped three modules in a row, the engagement engine 116 may be programmed to determine that the advertisements presented in those modules are not of any value to the consumer (even though they may have achieved high engagement and revenue scores from past engagements). As such, the engagement engine 116 may subsequently select other advertisements for presenting in subsequent module that are selected based on one or more different attributes.

In a particular embodiment, the advertisement system 10 may be configured to serve engagement offers and advertisements to consumers that are interacting with digital content by way of a native mobile application. In a particular embodiment, this is achieved by placing the widget script 121 on an i-frame embedded into the mobile application. It will be understood that other techniques for implementing the data-gatherer script may also be utilised and are within the purview of the skilled person.

In an alternative embodiment to that described above, rather than evaluating context data and/or user consumer attribute data for determining which engagement offers to present, the advertisement system (and more particularly the ranking engine 118) may instead base the selection on a historical performance of the engagement offers stored in the objects database 115. In a particular embodiment, the historical performance may be measured in much the same manner as for the engagement score, but focused only on those metrics relating to the engagement offer 18. For example, the historical performance may be calculated by summing the engagement offer take-ups and engagement offer skips/declines count. The ranking engine 118 may additionally apply a filter when determining the performance score such that only those scores that have recorded within some predefined time period are evaluated to keep up to date with current trends.

### Further Detail of System Configuration

The server computer 112 on which the advertisement system 10 is implemented can be any form of suitable server computer that is capable of communicating with the consumer devices 106. The server 112 may include typical web server hardware including a processor, motherboard, memory, hard disk and a power supply. The server also includes an operating system which co-operates with the hardware to provide an environment in which software applications can be executed. In this regard, the hard disk of the server is loaded with a processing module which, under the control of the processor, is operable to implement the various afore-described engagement and ranking engines 116, 118 for determining engagement offers and advertisements.

It will be appreciated that a distinct advantage arising through use of a third party advertisement system 10 as described above is that the third party advertisement system 10 effectively provides a unique engagement model/platform allowing multiple advertisers 14 to connect to multiple end users 16 across a range of different subscribing publisher sites 12. In this manner it will be appreciated that the advertising system 10 may provide advertisers 14 with a broad and immediate set of publishers 12 with whom they can partner to display their advertisements. Further, the ability to inter-connect stakeholders in this manner allows the advertising system 10 to provide a rich and deep pool of advertising content that can be drawn on to better match individual consumers with individual advertisers, in turn increasing the likelihood of a positive engagement. It will also be appreciated that this rich and deep pool addresses the variability in supply and demand of advertising on publisher sites. Yet another advantage arising through such an implementation is the ability to maintain a database storing behavioural metrics for consumers across a range of different publisher sites. Thus, even if a consumer has not previously accessed one of the subscribing publisher sites, the advertisement system 10 may still be able to provide tailored advertising to that consumer when visiting the new publisher site based on behaviour metrics recorded for that consumer based on past engagements while visiting other subscribing publisher sites. Thus, it can be seen that engagement model as described herein advantageously meets the needs of all stakeholders, and not just a subset thereof (as is the case for conventional methods).

According to the illustrated embodiment, the mobile devices are Internet-enabled smartphones. The smartphones are equipped with the necessary hardware and software to communicate with the web service. The smartphone and web service communicate over a network which, in this case, is a mobile broadband network 108. Although not illustrated in FIG. 1, the network 108 includes standard network elements including a base station controller, home location register, mobile switching centre, message centre, equipment identity register, and message gateway (although it will be appreciated that any suitable network connection may be utilised including private/public wireless networks, etc.).

It will be appreciated that the user computer device 106 could be any suitable form of network-enabled computing device. For example, the user computer device may be a general purpose computer or a special purpose device including a smart phone (as afore-described), tablet, or the like. Details of such devices (e.g. processor, memory, displays, data storage devices) are omitted for the sake of clarity.

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

The claims defining the invention are as follows:

1. A computer implemented method for presenting advertising to a computer user interfacing with digital content via a presentation interface, the method comprising the steps of:
determining one or more of (a) context data representative of how the computer user is interfacing with the digital content and (b) user attribute data representative of one or more attributes of the computer user;
selecting an engagement offer from a pool of different engagement offers based, at least in part, on the determined context data and/or user attribute data;
presenting the selected engagement offer to the computer user; and
responsive to the computer user accepting the engagement offer, presenting the computer user with one or more digital advertisements.

2. A computer implemented method in accordance with claim 1, wherein the context data is derived through evaluation of a content type of the digital content and/or an interaction made by the computer user with the digital content.

3. A computer implemented method in accordance with claim 2, wherein, where the interaction relates to the purchase of goods and/or services, and the context data is representative of at least one of a type, value and location of the goods/services.

4. A computer implemented method in accordance with claim 2, wherein the content type of the digital content is determined through an evaluation of at least one of the following: a URL of a resource providing the digital content; scraping a webpage providing the digital content for keywords and predefined content; application programming interface parameters associated with the digital content.

5. A computer implemented method in accordance with claim 1, wherein the user attribute data is representative of at least one of a time and location of the computer user when interfacing with the digital content.

6. A computer implemented method in accordance with claim 1, wherein the user attribute data is representative of one or more of the following: age, gender, social media profile.

7. A computer implemented method in accordance with claim 1, wherein the user attribute data comprises feedback data from previous engagement offers and/or advertisements presented to the computer user.

8. A computer implemented method in accordance with claim 1, further comprising determining user attribute data for at least one other computer user, wherein the user attribute data for the at least one other computer user comprises feedback data from engagement offers and/or advertisements previously presented to other computer users.

9. A computer implemented method in accordance with claim 7, wherein the feedback data comprises a behavioural metric related to how engaged the user was while interacting with the previously presented engagement offers and/or advertisements.

10. A computer implemented method in accordance with claim 1, wherein the feedback data comprises advertising revenue resulting from the presentation of engagement offers and/or advertisements.

11. A computer implemented method in accordance with claim 7, wherein the selection of an engagement offer is additionally dependent on the feedback data.

12. A computer implemented method in accordance with claim 11, further comprising the step of selecting the advertisement(s) from a pool of different advertisements based, at least in part, on one of the determined context data, user attribute data and feedback data.

13. A computer implemented method in accordance with claim 12, further comprising the step of selecting a number of the advertisements to present to the computer user based, at least in part, on one or more of the determined context data, user attribute data and feedback.

14. A computer implemented method in accordance with claim 12, further comprising the step of dynamically modifying the advertisement selection post engagement, based on feedback data from a preceding advertisement.

15. A computer system for presenting advertising to a computer user interfacing with digital content via a presentation interface, the system comprising:
a user computer implementing the presentation interface;
a server processing module connected to the user computer and operable to:
communicate with the presentation interface to determine one or more of (a) context data representative of how the computer user is interfacing with the digital content and (b) user attribute data representative of one or more attributes of the computer user;
select an engagement offer from a pool of different engagement offers based, at least in part, on the determined context data and/or user attribute data;
facilitate presentation of the selected engagement offer to the user computer; and
responsive to the computer user accepting the engagement offer, facilitate presentation of one or more digital advertisements to the user computer.

16. A computer implemented method for presenting advertising by a third party advertising system to a computer user interfacing with digital content on a subscribing publisher site, the method comprising the steps of:
determining a historical performance of one or more of engagement offers that have been previously presented to the computer user and/or another computer user while accessing digital content on the subscribing publisher site and/or another publisher site subscribing to the third party advertising system;
selecting the engagement offer that achieved the best historical performance for presenting to the computer user while interfacing with the digital content; and
responsive to the computer user accepting the engagement offer, presenting the computer user with one or more digital advertisements.

17. A computer implemented method for presenting advertising in accordance with claim 16, wherein the historical performance is derived from one or more behavioural metrics which measure how engaged the user was while interacting with the previously presented advertisements.

18. A computer implemented method in accordance with claim 16, wherein the historical performance is derived from one or more behavioural metrics which measure advertising revenue resulting from the presentation of the advertisements.

19. A computer implemented method for presenting advertising to computer users while interfacing with digital content provided by one of a plurality of different publisher sites subscribing to a third party advertising system, the third party advertising system being operable to:
maintain a database of digital advertisements; and
present one or more of the digital advertisements to a computer user responsive to determining an engagement trigger resulting from the computer user interfacing with digital content provided by one of the plurality of subscribing publisher sites.

20. A computer implemented method for presenting advertising in accordance with claim 19, wherein responsive to determining the engagement trigger the method further comprises determining one or more of (a) context data representative of how the computer user is interfacing with the digital content and (b) user attribute data representative of one or more attributes of the computer user; selecting an engagement offer from a pool of different engagement offers stored in the database based, at least in part, on the determined context data and/or user attribute data; and presenting the selected engagement offer to the computer user before presenting the one or more digital advertisements.

21. A computer implemented method for presenting advertising in accordance with claim 19, wherein responsive to determining the engagement trigger the method further comprises determining a historical performance of one or more of engagement offers that have been previously presented to the computer user and/or another computer user while accessing digital content on a subscribing publisher site; and selecting the engagement offer that achieved the best historical performance for presenting to the computer user prior to presenting the one or more digital advertisements.
